(19) United States
(12) Patent Application Publication
(10) Pub. No.: US 2010/0232454 A1
(43) Pub. Date: Sep. 16, 2010

(54) Communication apparatus

(75) Inventor: Hidehiko Kumazawa, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/661,065

(22) Filed: Mar. 10, 2010

(30) Foreign Application Priority Data
Mar. 12, 2009 (JP) 2009-059361

(51) Int. Cl. H04L 29/02

(52) U.S. Cl. 370/477; 340/436

(57) ABSTRACT

A communication apparatus includes a transmitter device and a receiver device connected to the transmitter device through a communication line. The transmitter device generates a multiplexed binary signal by adding together N types of binary signals having the same amplitude at a low level and different amplitudes at a high level, where N is an integer more than 1. The receiver device receives the multiplexed binary signal and translates the multiplexed binary signal into the N types of binary signals. One of the N types of binary signals has the minimum amplitude of all the N types of binary signals at the high level. An amplitude of each of the N types of binary signals is defined as a product of the minimum amplitude and 2^{M-1}, where M is an integer from 1 to N.

### CROSS REFERENCE TO RELATED APPLICATION

This application is based on and incorporates herein by reference Japanese Patent Application No. 2009-59361 filed on Mar. 12, 2009.

### FIELD OF THE INVENTION

The present invention relates to a communication apparatus including a transmitter device and a receiver device that are connected together through a communication line.

### BACKGROUND OF THE INVENTION

It has been proposed a communication apparatus including a transmitter device and a receiver device that are connected through a communication line. An example of such a communication apparatus is an occupant protection apparatus disclosed in U.S. Pat. No. 7,546,192 corresponding to JP-2003-258821A. The occupant protection apparatus includes a master unit and a satellite unit. The master unit and the satellite unit are connected through a communication line. The master unit successively transmits an address signal and a request signal. The satellite unit successively receives the address signal and the request signal from the master unit. The satellite unit transmits collision data to the master unit through the communication line based on the address signal and the request signal. The master signal receives the collision data from the satellite unit and deploys an airbag based on the collision data.

The address signal and the request signal are transmitted and received as a binary signal having two discrete values, i.e., a logic low level and a logic high level having a constant amplitude. The amount of information carried per unit of time can be increased by increasing a frequency of the binary signal. However, as the frequency of the binary signal is increased, noise accompanied with transition between the high level and the low level is increased.

### SUMMARY OF THE INVENTION

In view of the above, it is an object of the present invention to provide a communication apparatus for increasing the amount of information carried per unit of time without increasing a frequency of a binary signal.

According to an aspect of the present invention, a communication apparatus includes a transmitter device and a receiver device that are connected together through a communication line. The transmitter device generates a multiplexed binary signal by adding N types of binary signals having the same amplitude at a low level and different amplitudes at a high level, where N is an integer more than 1. The receiver device receives the multiplexed binary signal and translates the multiplexed binary signal into the N types of binary signals. One of the N types of binary signals has the minimum amplitude of all the N types of binary signals at the high level. An amplitude of each of the N types of binary signals at the high level is defined as a product of the minimum amplitude and 2^{M}-1, where M is an integer from 1 to N.

According to another aspect of the present invention, a communication apparatus includes a transmitter device and a receiver device that are connected together through a communication line. The transmitter device successively transmits multiple types of binary signals having the same amplitude at a low level and different amplitudes at a high level. The receiver device successively receives the multiple types of binary signals from the transmitter device. The receiver device determines a type of the binary signal based on the amplitude of the binary-signal at the high level.

### BRIEF DESCRIPTION OF THE DRAWINGS

The above and other objectives, features and advantages of the present invention will become more apparent from the following detailed description made with check to the accompanying drawings. In the drawings:

FIG. 1 is a block diagram of an occupant protection apparatus according to a first embodiment of the present invention;

FIG. 2 is a circuit diagram of a transmitter circuit of a control unit and a receiver circuit of a sensor unit of the occupant protection apparatus;

FIG. 3 is a circuit diagram of a transmitter circuit of the sensor unit and a receiver circuit of a control unit of the occupant protection apparatus;

FIG. 4 is a diagram illustrating binary signals A, B in the occupant protection apparatus of FIG. 1;

FIG. 5 is a diagram illustrating an operation of generating a multiplexed binary signal from the binary signals A, B;

FIG. 6 is a diagram illustrating an operation of generating the binary signals A, B from the multiplexed binary signal;

FIG. 7A is a timing chart of the binary signal A, FIG. 7B is a timing chart of the binary signal B, and FIG. 7C is a timing chart of the multiplexed binary signal;

FIG. 8 is a diagram illustrating binary signals C, D responding to the binary signals A, B;

FIG. 9 is a diagram illustrating an operation of generating a multiplexed binary signal from the binary signals C, D;

FIG. 10 is a diagram illustrating an operation of generating the binary signals C, D from the multiplexed binary signal;

FIG. 11 is a circuit diagram according to a modification of the first embodiment;

FIG. 12 is a diagram illustrating binary signals E, F, and G in an occupant protection apparatus according to a second embodiment of the present invention;

FIG. 13A is a diagram illustrating an operation of generating the binary signal E, FIG. 13B is a diagram illustrating an operation of generating the binary signal F, and FIG. 13C is a diagram illustrating an operation of generating the binary signal G;

FIG. 14 is a diagram illustrating an operation of determining a logic state of the binary signal;

FIG. 15 is a diagram illustrating an operation of determining a type of the binary signal; and

FIG. 16 is a timing diagram of the binary signals E, F, and G.

### DETAILED DESCRIPTION OF THE PREFERRED EMBODIMENTS

### First Embodiment

Referring to the drawings, an occupant protection apparatus 1 according a first embodiment of the present invention is described as an example of a communication apparatus. The occupant protection apparatus 1 is mounted on a vehicle and used to protect an occupant of the vehicle.

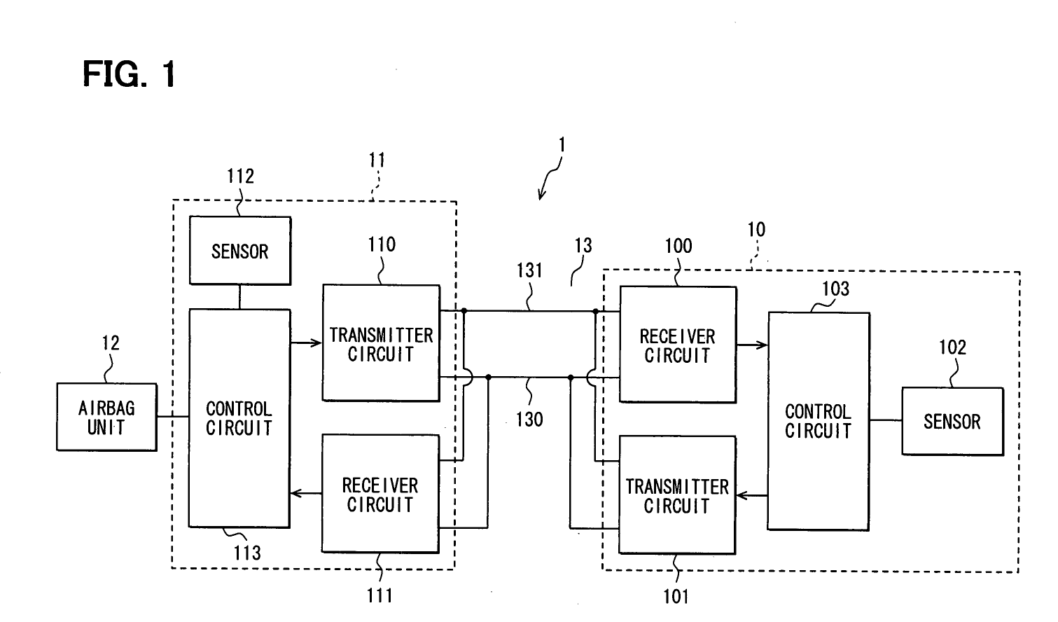

As shown in FIG. 1, the occupant protection apparatus 1 includes a sensor unit 10, a control unit 11, and an airbag unit 12. The sensor unit 10 and the control unit 11 are connected together through a communication line 13. The communication line 13 includes a reference line 130 and a transmission line 131.

The sensor unit 10 is placed in a predetermined position in the vehicle to detect a collision of the vehicle with an object. Specifically, the sensor unit 10 is configured to detect an acceleration of the vehicle. The sensor unit 10 receives a multiplexed binary request signal from the control unit 11. The multiplexed binary request signal is in the form of a voltage. The multiplexed binary request signal is generated by adding together multiple binary request signals including a command to the sensor unit 10. The sensor unit 10 translates (i.e., decodes) the received multiplexed binary request signal into the multiple binary request signals. Then, the sensor unit 10 generates a multiplexed binary response signal by adding together multiple binary response signals, each of which responds to a corresponding one of the multiple binary request signals. Then, the sensor unit 10 transmits the multiplexed binary response signal to the control unit 11. The multiplexed binary response signal is in the form of an electric current. Specifically, the sensor unit 10 includes a receiver circuit 100 (as a receiver device), a transmitter circuit 101 (as a transmitter device), a sensor 102, and a control circuit 103 (as a receiver device and a transmitter device).

The receiver circuit 100 receives from the control unit 11 the multiplexed binary request signal in the form of an electric current. The receiver circuit 100 translates the multiplexed binary request signal into the multiple binary request signals based on an amplitude of the multiplexed binary request signal. The-receiver circuit 100 outputs the multiple binary request signals to the control circuit 103. The receiver circuit 100 is connected to the control unit 11 through the communication line 13.

The control circuit 103 generates the multiple binary response signals, each of which responds to a corresponding one of the multiple binary request signals. The control circuit 103 outputs the multiple binary response signals to the transmitter circuit 101. The transmitter circuit 101 generates the multiplexed binary response signal by adding together the multiple binary response signals and transmits to the control unit 11 the multiplexed binary response signal in the form of a voltage. The control circuit 103 is connected to the transmitter circuit 101 through the communication line 13.

The sensor 102 is a device for detecting a collision of the vehicle with an object. Specifically, the sensor 102 is configured to detect an acceleration of the vehicle.

The control circuit 103 controls the sensor 102 based on the multiple binary request signals that are outputted from the receiver circuit 100. The control circuit 103 outputs to the transmitter circuit 101 the multiple binary response signals including a measurement detected by the sensor 102. The control circuit 103 is connected to each of the receiver circuit 100, the transmitter circuit 101, and the sensor 102.

In order to get a response from the sensor unit 10 (e.g., the measurement detected by the sensor 102), the control unit 11 generates the multiplexed binary request signal by adding multiple binary request signals together. Then, the control unit 11 outputs to the sensor unit 10 the multiplexed binary request signal in the form of a voltage. In response to the multiplexed binary request signal, the sensor unit 10 outputs to the control unit 11 the multiplexed binary response signal in the form of an electric current. The control unit 11 receives the multiplexed binary response signal and translates the multiplexed binary response signal into multiple binary response signals including the measurement detected by the sensor 102. In this way, the control unit 11 gets the measurement detected by the sensor 102. The control unit 11 outputs a firing signal to the airbag unit 12 based on the measurement detected by the sensor 102 and a measurement detected by the sensor 112. Specifically, the control unit 11 includes a transmitter circuit 110 (as a transmitter device), a receiver circuit 111 (as a receiver device), a sensor 112, and a control circuit 113 (as a receiver device and a transmitter device).

The control circuit 113 generates the multiple binary request signals including a command to get the measurement detected by the sensor unit 10. The transmitter circuit 110 generates the multiplexed binary request signal by adding together the multiple binary request signals and outputs to the receiver circuit 100 of the sensor unit 10 the multiplexed binary request signal in the form of a voltage. The transmitter circuit 110 is connected to the receiver circuit 100 through the communication line 13.

The receiver circuit 111 receives from the transmitter circuit 101 of the sensor unit 10 the multiplexed binary response signal in the form an electric current. The receiver circuit 111 translates the multiplexed binary response signal into the multiple binary response signals based on an amplitude of the multiplexed binary response signal. The receiver circuit 111 outputs the multiple binary response signals to the control circuit 113. The receiver circuit 111 is connected to the transmitter circuit 101 through the communication line 13.

The sensor 112 is incorporated in the control unit 11 and detects a collision of the vehicle with an object. Specifically, the sensor 112 is configured to detect an acceleration of the vehicle.

The control circuit 113 outputs the firing signal to the airbag unit 12 based on the measurement detected by the sensor unit 10 and the measurement detected by the sensor 112. Specifically, the control circuit 113 outputs to the transmitter circuit 110 the multiple binary request signals including the command to get the measurement detected by the sensor unit 10 and receives from the receiver circuit 111 the multiple binary request signals including the measurement detected by the sensor unit 10. Then, the control circuit 113 outputs the firing signal to the airbag unit 12 based on the measurement detected by the sensor unit 10 and the measurement detected by the sensor 112. The control circuit 113 is connected to each of the transmitter circuit 110, the receiver circuit 111, and the sensor 112.

The airbag unit 12 deploys an airbag based on the firing signal that is outputted from the control circuit 113 of the control unit 11, thereby protecting an occupant of the vehicle from a collision. The airbag unit 12 is connected to the control circuit 113.

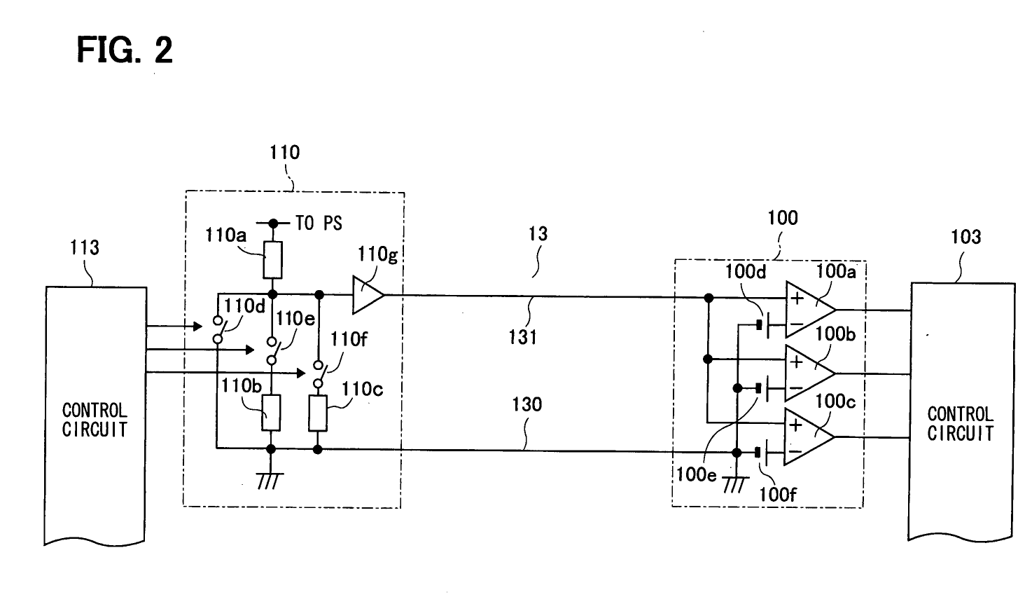

Below, the transmitter circuit 110 of the control unit 11 and the receiver circuit 100 of the sensor unit 10 are described in detail with reference to FIG. 2. FIG. 2 is a circuit diagram of the transmitter circuit 110 and the receiver circuit 100 that are connected together through the communication line 13.

As shown in FIG. 2, the transmitter circuit 110 of the control unit 11 includes resistors 110a-110c, switches 110d-110f, and a buffer 110g. It is noted that a resistance ratio of the resistor 110a to the resistor 110b to the resistor 110c is 2 to 1 to 4. A first end of the resistor 110a is connected to a power source (PS). The power source can supply a voltage of 3V. A second end of the resistor 110a is grounded through the switch 110d and connected to the reference line 130. Further, the second end of the resistor 110a is grounded through the resistor 110b and the switch 110e and connected to the reference line 130. Furthermore, the second end of the resistor 110a is grounded through the resistor 110c and the switch 110f and connected to the reference line 130. Furthermore, the second end of the resistor 110a is connected to the transmission line 131 through the buffer 110g. The buffer 110g has high input resistance. Control terminals of the switches 110d-110f are connected to the control circuit 113 so that the control circuit 113 can control the switches 110d-110f.

The receiver circuit 100 of the sensor unit 10 includes comparators 100a-100c and reference (REF) power supplies 100d-100f. The reference power supply 100d supplies a voltage of 0.5V (volts). The reference power supply 100e supplies a voltage of 1.5V. The reference power supply 100f supplies a voltage of 2.5V. Non-inverting input terminals of the comparators 100a-100c are connected to the transmission line 131. An inverting input terminal of the comparator 100a is connected to a positive terminal of the reference power supply 100d. A negative terminal of the reference power supply 100d is connected to the reference line 130. An inverting input terminal of the comparator 100b is connected to a positive terminal of the reference power supply 100e. A negative terminal of the reference power supply 100e is connected to the reference line 130. An inverting input terminal of the comparator 100c is connected to a positive terminal of the reference power supply 100f. A negative terminal of the reference power supply 100f is connected to the reference line 130. Output terminals of the comparators 100a-100c are connected to the control circuit 103.

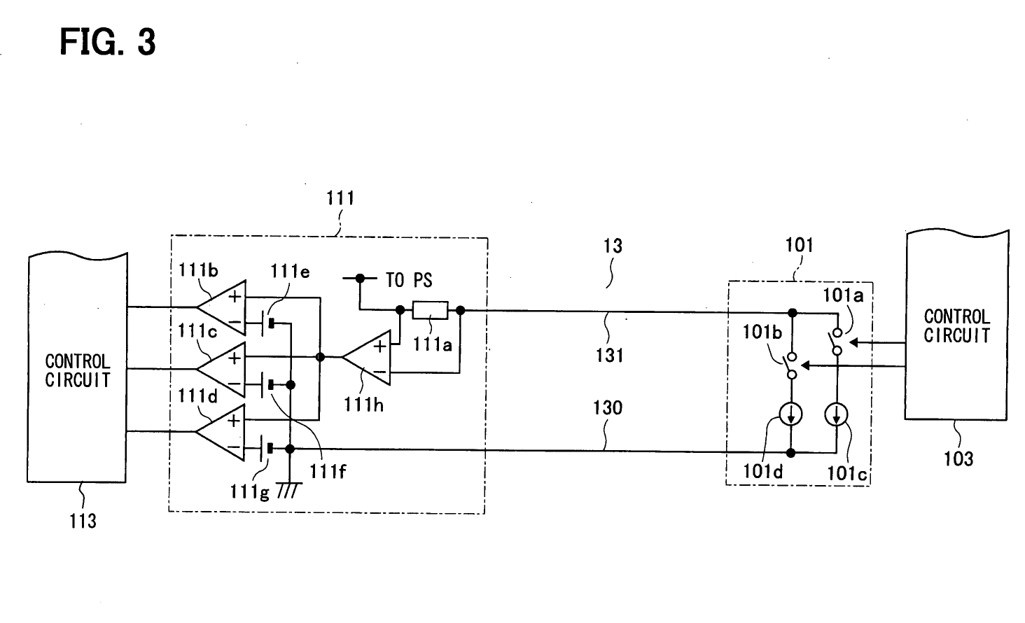

Below, the transmitter circuit 101 of the sensor unit 10 and the receiver circuit 111 of the control unit 10 are described in detail with reference to FIG. 3. FIG. 3 is a circuit diagram of the transmitter circuit 101 and the receiver circuit 111 that are connected together through the communication line 13.

As shown in FIG. 3, the transmitter circuit 101 includes switches 101a, 101b and current sources 101c, 101d. The current source 101c supplies an electric current of IA (I amperes), and the current source 101d supplies an electric current of 2 IA, where I is a positive number. That is, an output current ratio of the current source 101c to the current source 101d is 1 to 2. A first end of the switch 101a is connected to the transmission line 131. A second end of the switch 101a is connected to the reference line 130 through the current source 101c. A first end of the switch 101b is connected to the transmission line 131. A second end of the switch 101b is connected to the reference line 130 through the current source 101d. Control terminals of the switches 101a, 101b are connected to the control circuit 103 so that the control circuit 103 can control the switches 101a, 101b.

The receiver circuit 111 of the control unit 11 includes a resistor 111a, an operational amplifier 111h, comparators 111b-111d, and reference power supplies 111e-111g. A resistance of the resistor 111a is set so that a difference in voltage across the resistor 111a between when an electric current of IA flows from the current source 101c and when no electric current flows can be 1V. The reference power supply 111e supplies a voltage of 0.5V. The reference power supply 111f supplies a voltage of 1.5V. The reference power supply 111g supplies a voltage of 2.5V. A first end of the resistor 111a is connected to the power source of 3V. A second end of the resistor 111a is connected to the transmission line 131. A non-inverting input terminal of the operational amplifier 111h is connected to the first end of the resistor 111a, and an inverting input terminal of the operational amplifier 111h is connected to the second end of the resistor 111a. Non-inverting input terminals of the comparators 111b-111d are connected to an output terminal of the operational amplifier 111h. An inverting input terminal of the comparator 111b is connected to a positive terminal of the reference power supply 111e. A negative terminal of the reference power supply 111e is grounded. An inverting input terminal of the comparator 111c is connected to a positive terminal of the reference power supply 111f. A negative terminal of the reference power supply 111f is grounded. An inverting input terminal of the comparator 111d is connected to a positive terminal of the reference power supply 111g. A negative terminal of the reference power supply 111g is grounded. Output terminals of the comparators 111b-111d are connected to the control circuit 113. It is noted that the reference line 130 is grounded in the receiver circuit 111.

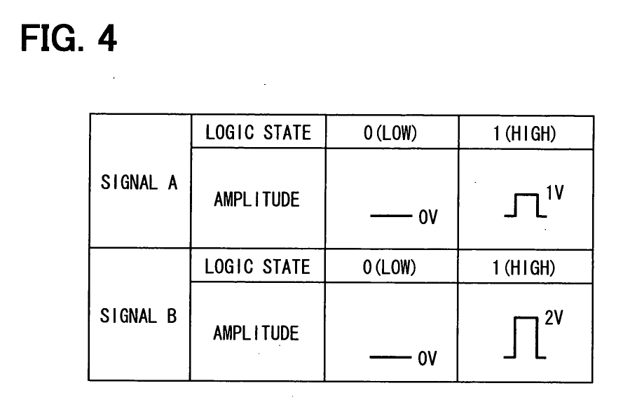

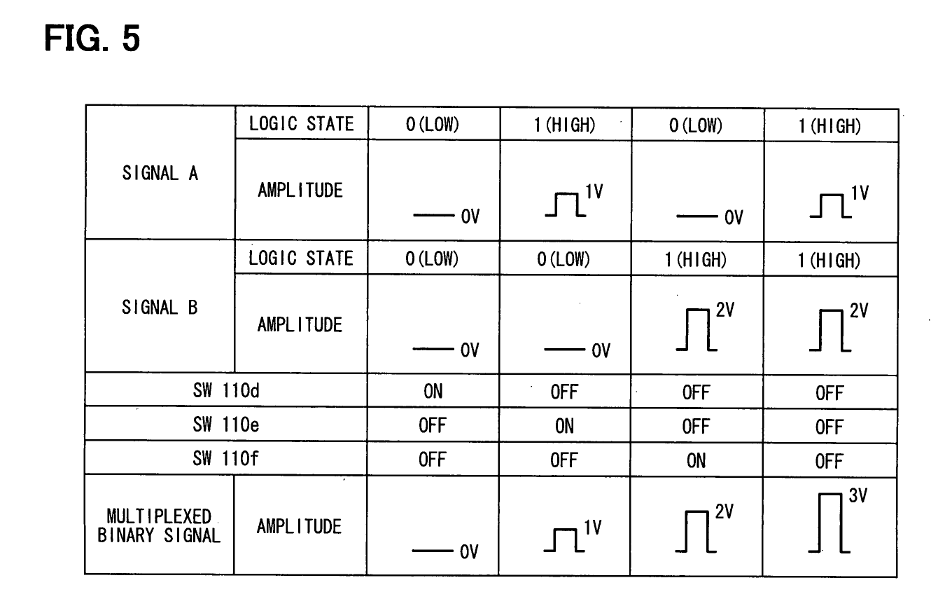

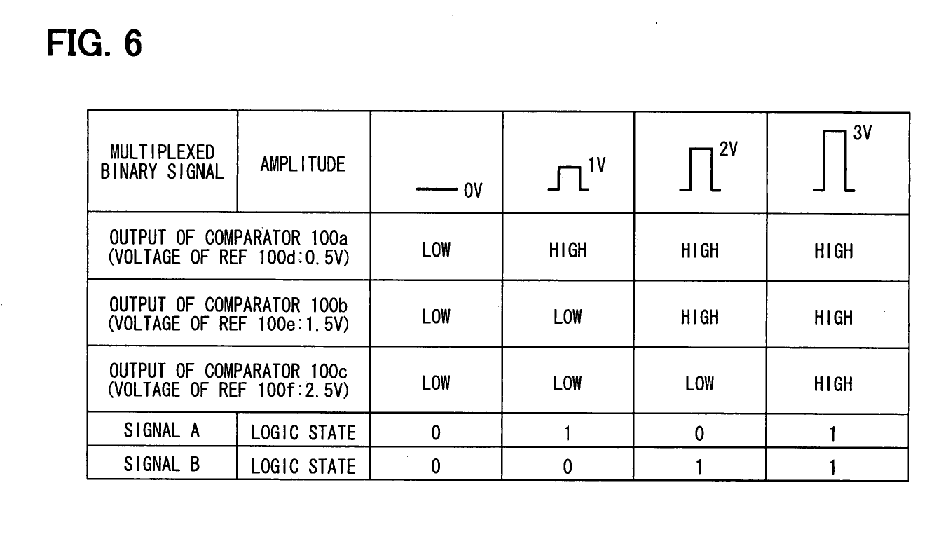

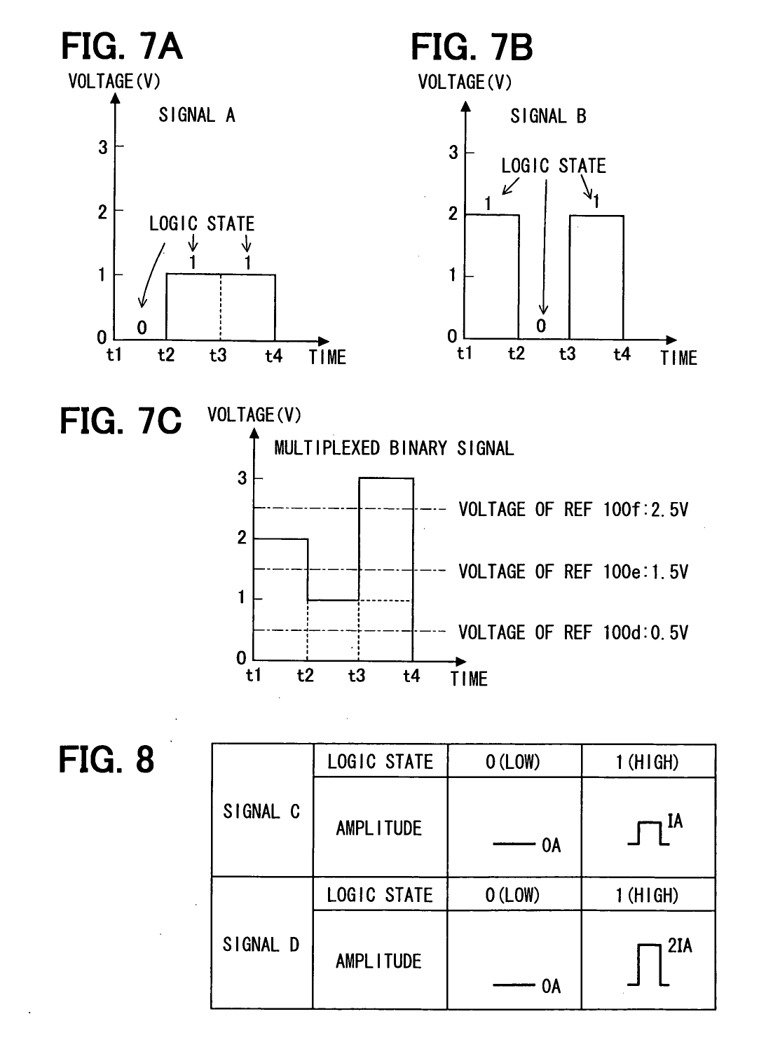

Next, transmission and reception operations between the transmitter circuit 110 of the control unit 11 and the receiver circuit 100 of the sensor unit 10 are described below with reference to FIG. 2 and FIGS. 4-7. FIG. 4 depicts two binary request signals A, B. FIG. 5 depicts an operation of generating a multiplexed binary request signal from the request signals A, B. FIG. 6 depicts an operation of generating the request signals A, B from the multiplexed binary request signal. FIG. 7 depicts a timing diagram of the request signals A, B and the multiplexed binary request signal. Firstly, the operation of generating the multiplexed binary request signal from the request signals A, B is described.

Referring to FIG. 2, the control circuit 113 generates two types of request signals A, B such as commands to the sensor unit 10. Each of the signals A, B is a binary signal having a high level corresponding to a logic state of “1” and a low level corresponding to a logic state of “0”. As shown in FIG. 4, when the signal A has a logic state of “0” (i.e., low level), an amplitude of the signal A is 0V, and when the signal A has a logic state of “1” (i.e., high level), the amplitude of the signal A is 1V. On the other hand, when the signal B has a logic state of “0” (i.e., low level), an amplitude of the signal B is 0V, and when the signal B has a logic state of “1” (i.e., high level), the amplitude of the signal B is 2V. In summary, although the amplitude of the signal B is equal to the amplitude of the signal B at a low level, the amplitude of the signal B is twice greater than the amplitude of the signal A at a high level.

Referring back to FIG. 2, the control circuit 113 controls the transmitter circuit 110 to generate the multiplexed binary request signal by adding the signals A, B together and transmit the multiplexed binary request signal to the receiver circuit 100. Specifically, the control circuit 113 controls the switches 110d-110f so that the signals A, B can be added together to generate the multiplexed binary request signal.

Specifically, as shown in FIG. 5, when each of the signals A, B has a logic state of “0”, the control circuit 113 turns ON only the switch 110d. When the switch 110d is turned ON, the second end of the resistor 110a is grounded. As a result, a voltage at the second end of the resistor 110a becomes 0V. In this way, the signal A having the amplitude of 0V and the signal B having the amplitude of 0V are added together to generate the multiplexed binary request signal having an amplitude of 0V.

When the signal A has a logic state of “1”, and the signal B has a logic state of “0”, the control circuit 113 turns ON only the switch 110e. When the switch 110e is turned ON, the resistors 110a, 110b are connected in series so that the power source voltage of 3V can be divided by the resistors 110a, 110b. As mentioned previously, the resistance ratio of the resistor 110a to the resistor 110b is 2 to 1. Therefore, the voltage at the second end of the resistor 110a becomes 1V. In this way, the signal A having the amplitude of 1V and the signal B having the amplitude of 0V are added together to generate the multiplexed binary request signal having the amplitude of 1V.

When the signal A has a logic state of “0”, and the signal B has a logic state of “1”, the control circuit 113 turns ON only the switch 110f. When the switch 110f is turned ON, the resistors 110a, 110c are connected in series so that the power supply voltage of 3V can be divided by the resistors 110a, 110c. As mentioned previously, the resistance ratio of the resistor 110a to the resistor 110c is 2 to 4 (i.e., 1 to 2). Therefore, the voltage at the second end of the resistor 110a becomes 2V. In this way, the signal A having the amplitude of 0V and the signal B having the amplitude of 2V are added together to generate the multiplexed binary request signal having the amplitude of 2V.

When each of the signals A, B has a logic state of “1”, the control circuit 113 turns OFF all the switches 110d-110f. When all the switches 110d-110f are turned OFF, the voltage at the second end of the resistor 110a becomes 3V. In this way, the signal A having the amplitude of 1V and the signal B having the amplitude of 2V are added together to generate the multiplexed binary request signal having the amplitude of 3V.

For example, as shown in FIGS. 7A-7C, when the signal A has a logic state of “011”, and the signal B has a logic state of “101”, the control circuit 113 controls the switches 110d-110f to generate the multiplexed binary request signal having an amplitude of 2V during a period of time from t1 to t2, an amplitude of 1V during a period of time from t2 to t3, and an amplitude of 3V during a period of time from t3 to t4. Then, the multiplexed binary request signal is outputted from the buffer 110g and transmitted to the receiver circuit 100 through the communication line 13.

Next, the operation of generating the request signals A, B from the multiplexed binary request signal is described. Referring to FIG. 2, the comparators 100a-100c of the receiver circuit 100 compares a voltage of the multiplexed binary request signal with the voltages of the reference power supplies 100d-100f, respectively.

As shown in FIG. 6, when the multiplexed binary request signal has an amplitude of 0V, the voltage of the multiplexed binary request signal is less than each of the voltages of the reference power supplies 100d-100f. Therefore, each of the comparators 100a-100c outputs a low level signal. When all the outputs of the comparators 100a-100c are at a low level, the control circuit 103 determines that each of the signals A, B has a logic state of “0”.

When the multiplexed binary request signal has an amplitude of 1V, the voltage of the multiplexed binary request signal is greater than the voltage of the reference power supply 100d. Therefore, the comparator 100a outputs a high level signal. In contrast, since the voltage of the multiplexed binary request signal is less than each of the voltages of the reference power supplies 100e, 100f, each of the comparators 100b, 100c outputs a low level signal. When the output of the comparator 100a is at a high level, and each of the outputs of the comparators 100b, 100c is at a low level, the control circuit 103 determines that the signal A has a logic state of “1” and that the signal B has a logic state of “0”.

When the multiplexed binary request signal has an amplitude of 2V, the voltage of the multiplexed binary request signal is greater than each of the voltages of the reference power supplies 100d, 100e. Therefore, each of the comparators 100a, 100b outputs a high level signal. In contrast, since the voltage of the multiplexed binary request signal is less than the voltage of the reference power supply 100f, the comparator 100c outputs a low level signal. When each of the outputs of the comparators 100a, 100b is at a high level, and the output of the comparator 100c is at a low level, the control circuit 103 determines that the signal A has a logic state of “0” and that the signal. B has a logic state of “1”.

When the multiplexed binary request signal has an amplitude of 3V, the voltage of the multiplexed binary request signal is greater than each of the voltages of the reference power supplies 100d-100f. Therefore, each of the comparators 100a-100c outputs a high level signal. When all the outputs of the comparators 100a-100c are at a high level, the control circuit 103 determines that each of the signals A, B has a logic state of “1”.

For example, as shown in FIGS. 7A-7C, the control circuit 103 determines that the signal A has a logic state of “011” and that the signal B has a logic state of “101”, when the multiplexed binary request signal has an amplitude of 2V during a period of time from t1 to t2, an amplitude of 1V during a period of time from t2 to t3, and an amplitude of 3V during a period of time from t3 to t4. In this way, the control circuit 103 determines logic states of the signals A, B and performs operations corresponding to the logic states.

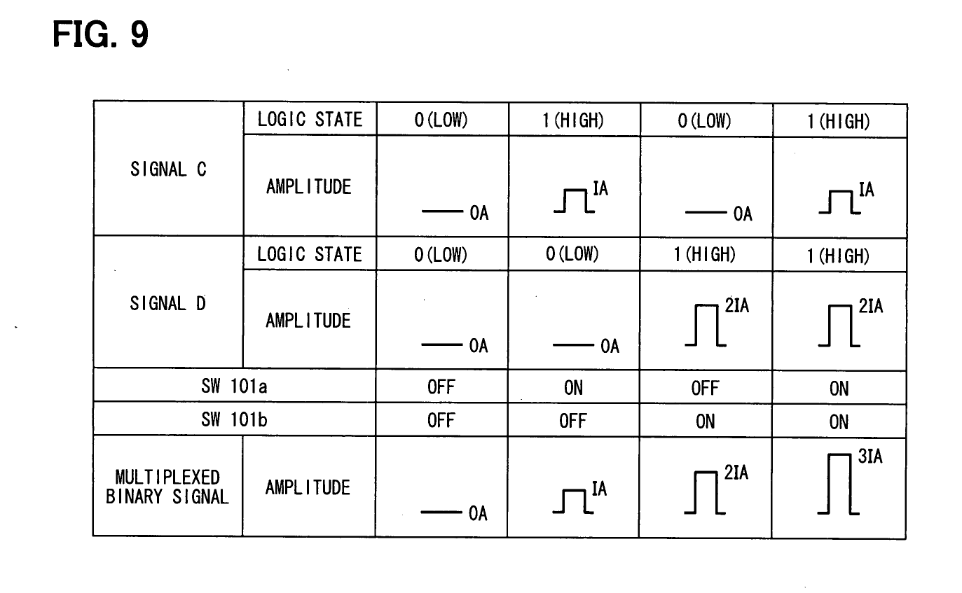

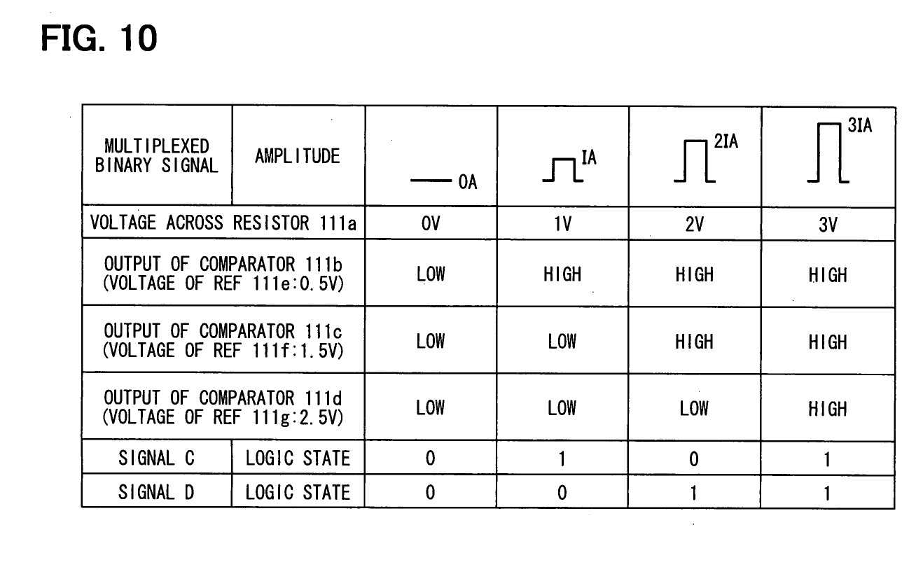

Next, transmission and reception operations between the receiver circuit 111 of the control unit 11 and the transmitter circuit 101 of the sensor unit 10 are described below with reference to FIG. 3 and FIGS. 8-10. FIG. 8 depicts binary response signals C, D. FIG. 9 depicts an operation of generating a multiplexed binary response signal from the response signals C, D. FIG. 10 depicts an operation of generating the response signals C, D from the multiplexed binary response signal. FIG. 10 depicts a timing diagram of the response signals C, D and the multiplexed binary response signal.

Firstly, the operation of generating the multiplexed binary response signal from the signals C, D is described.

Referring to FIG. 3, the control circuit 103 generates two types of response signals C, D as responses to the request signals A, B. Each of the signals C, D is a binary signal having a high level corresponding to a logic state of “1” and a low level corresponding to a logic state of “0”. As shown in FIG. 8, when the signal C has a logic state of “0” (i.e., low level), an amplitude of the signal C is 0A, and when the signal C has a logic state of “1” (i.e., high level), the amplitude of the signal C is IA. On the other hand, when the signal D has a logic state of “0” (i.e., low level), an amplitude of the signal D is 0A, and when the signal D has a logic state of “1” (i.e., high level), the amplitude of the signal D is 2 IA. In summary, although the amplitude of the signal C is equal to the amplitude of the signal D at a low level, the amplitude of the signal D is twice greater than the amplitude of the signal C at a high level.

Referring back to FIG. 3, the control circuit 103 controls the transmitter circuit 101 to generate the multiplexed binary response signal by adding the signals C, D together and transmit the multiplexed binary response signal to the receiver circuit 111. Specifically, the control circuit 103 controls the switches 101a, 101b so that the signals C, D can be added together to generate the multiplexed binary response signal.

As shown in FIG. 9, when each of the signals C, D has a logic state of “0”, the control circuit 103 turns OFF each of the switches 101a, 101b. When each the switches 101a, 101b is turned OFF, each of the current sources 101c, 101d supplies no electric current. As a result, a value of an electric current flowing through the communication line 13 becomes 0A. In this way, the signal C having the amplitude of 0A and the signal D having the amplitude of 0A are added together to generate the multiplexed binary response signal having an amplitude of 0A.

When the signal C has a logic state of “1”, and the signal D has a logic state of “0”, the control circuit 103 turns ON only the switch 101a. When the switch 101a is turned ON, the current source 101c supplies an electric current of IA. As a result, a value of an electric current flowing through the communication line 13 becomes IA. In this way, the signal C having the amplitude of IA and the signal D having the amplitude of 0A are added together to generate the multiplexed binary response signal having an amplitude of IA.

When the signal C has a logic state of “0”, and the signal D has a logic state of “1”, the control circuit 103 turns ON only the switch 101b. When the switch 101b is turned ON, the current source 101c supplies an electric current of 2 IA. As a result, a value of an electric current flowing through the communication line 13 becomes 2 IA. In this way, the signal C having the amplitude of 0A and the signal D having the amplitude of 2 IA are added together to generate the multiplexed binary response signal having an amplitude of 2 IA.

When each of the signals C, D has a logic state of “1”, the control circuit 103 turns ON each of the switches 101a, 101b. When each the switches 101a, 101b is turned ON, the current source 101c supplies an electric current of IA, and the current source 101d supplies an electric current of 2 IA. As a result, a value of an electric current flowing through the communication line 13 becomes 3 IA. In this way, the signal C having the amplitude of IA and the signal D having the amplitude of 2 IA are added together to generate the multiplexed binary response signal having an amplitude of 3 IA.

Then, the multiplexed binary response signal is transmitted to the receiver circuit 111 through the communication line 13.

Next, the operation of generating the signals C, D from the multiplexed binary response signal is described. Referring to FIG. 3, in the receiver circuit 111, the comparators 111b-111d compare a voltage across the resistor 111a with the voltages of the reference power supplies 111e-111g, respectively.

As shown in FIG. 6, when the multiplexed binary response signal has an amplitude of 0A, the voltage across the resistor 111a becomes 0V. In this case, the voltage across the resistor 111a is less than each of the voltages of the reference power supplies 111e-111g. Therefore, each of the comparators 111b-111d outputs a low level signal. When all the outputs of the comparators 111b-111d are at a low level, the control circuit 113 determines that each of the signals C, D has a logic state of “0”.

When the multiplexed binary response signal has an amplitude of IA, the voltage across the resistor 111a becomes 1V. In this case, the voltage across the resistor 111a is greater than the voltage of the reference power supply 111e. Therefore, the comparator 111b outputs a high level signal. In contrast, since the voltage across the resistor 111a is less than each of the voltages of the reference power supplies 111f, 111g, each of the comparators 111c, 111d outputs a low level signal. When the output of the comparator 111b is at a high level, and each of the outputs of the comparators 111c, 111d is at a low level, the control circuit 113 determines that the signal C has a logic state of “1” and that the signal D has a logic state of “0”.

When the multiplexed binary response signal has an amplitude of 2 IA, the voltage across the resistor 111a becomes 2V. In this case, the voltage across the resistor 111a is greater than each of the voltages of the reference power supplies 111e, 111f. Therefore, each of the comparators 111b, 111c outputs a high level signal. In contrast, since the voltage across the resistor 111a is less than the voltage of the reference power supply 111g, the comparator 111d outputs a low level signal. When each of the outputs of the comparators 111b, 111c is at a high level, and the output of the comparator 111d is at a low level, the control circuit 113 determines that the signal C has a logic state of “0” and that the signal D has a logic state of “1”.

When the multiplexed binary response signal has an amplitude of 3 IA, the voltage across the resistor 111a becomes 3V. In this case, the voltage across the resistor 111a is greater than each of the voltages of the reference power supplies 111e-111g. Therefore, each of the comparators 111b-111d outputs a high level signal. When all the outputs of the comparators 111b-111d are at a high level, the control circuit 113 determines that each of the signals C, D has a logic state of “1”. In this way, the control circuit 113 determines logic states of the signals C, D.

Then, the control unit 11 outputs the firing signal to the airbag unit 12 based on the measurement detected by the sensor unit 10 and the measurement detected by the sensor 112. The airbag unit 12 deploys an airbag based on the firing signal outputted from the control unit 11, thereby protecting an occupant of the vehicle from a collision.

As described above, according to the first embodiment, the multiplexed binary request signal is generated by adding together two types of binary request signals A, B. As shown in FIG. 4, the signals A, B have the same amplitude at a low level, but have different amplitudes at a high level. Specifically, the amplitude of the signal B is twice greater than the amplitude of the signal A at a high level. In such an approach, as shown in FIG. 5, the multiplexed binary request signal can have a different amplitude for every possible combination of the levels of the signals A, B. In other words, the amplitude of the multiplexed binary request signal uniquely corresponds to each combination of the levels of the signals A, B. Therefore, the multiplexed binary request signal can be translated into the signals A, B based on the amplitude of the multiplexed binary request signal.

Likewise, the multiplexed binary response signal is generated by adding together two types of binary response signals C, D. As shown in FIG. 8, the signals C, D have the same amplitude at a low level, but have different amplitudes at a high level. Specifically, the amplitude of the signal D is twice greater than the amplitude of the signal C at a high level. In such an approach, as shown in FIG. 9, the multiplexed binary response signal can have a different amplitude for every possible combination of the levels of the signals C, D. In other words, the amplitude of the multiplexed binary response signal uniquely corresponds to each combination of the levels of the signals C, D. Therefore, the multiplexed binary response signal can be translated into the signals C, D based on the amplitude of the multiplexed binary response signal.

It is noted that since the multiplexed binary signal is generated by adding the binary signals together, a frequency of the'multiplexed binary signal is equal to a frequency of the binary signal. Thus, the amount of information carried between the sensor unit 10 and the control unit 11 can be increased without increasing the frequency of the binary signal.

Further, according to the first embodiment, as shown in FIGS. 6 and 10, the multiplexed binary signal can have four different amplitudes. Therefore, two type of binary signals can be surely generated from the multiplexed binary signal by using three reference power supplies 111e-111g having different voltages as threshold values.

Further, according to the first embodiment, the multiplexed binary request signal transmitted from the transmitter circuit 110 of the control unit 11 to the receiver circuit 100 of the sensor unit 10 is in the form of a voltage. In contrast, the multiplexed binary response signal transmitted from the transmitter circuit 101 of the sensor unit 10 to the receiver circuit 111 of the control unit 11 is in the form of an electric current. Therefore, the multiplexed binary request signal and the multiplexed binary response signal can be surely distinguished from each other.

Further, according to the first embodiment, the multiplexed binary signal is generated by adding together two types of binary signals. The number of types of binary signals added together to generate a multiplexed binary signal is not limited to two. For example, three types of binary signals can be added together to generate a multiplexed binary signal. In this case, the three binary signals should have the same amplitude at a low level and have different amplitudes at a high level. It is noted that an amplitude ratio of the three binary signals at a high level should be 1 to 2 to 4. In such an approach, the multiplexed binary signal can have a different amplitude for every possible combination of levels of the three binary signals. The multiplexed binary signal can be surely translated into the three binary signals by using three threshold values.

For another example, four types of binary signals can be added together to generate a multiplexed binary signal. In this case, the four binary signals should have the same amplitude at a low level and have different amplitudes at a high level. It is noted that an amplitude ratio of the four binary signals at a high level should be 1 to 2 to 4 to 8. In such an approach, the multiplexed binary signal can have a different amplitude for every possible combination of levels of the four binary signals. The multiplexed binary signal can be surely translated into the four binary signals by using fifteen threshold values.

In summary, N types of binary signals can be added together to generate a multiplexed binary signal, where N is an integer more than 1. In this case, the N binary signals should have the same amplitude at a low level and have different amplitudes at a high level. Specifically, assuming that one of the N binary signals has the minimum amplitude at a high level, an amplitude of each of the N binary signals at a high level is defined as a product of the minimum amplitude and 2^{M}-1, where M is an integer from 1 to N. In such an approach, the multiplexed binary signal can have a different amplitude for every possible combination of levels of the N binary signals. The multiplexed binary signal can be surely translated into the N binary signals by using (2^{N}-1) threshold values.

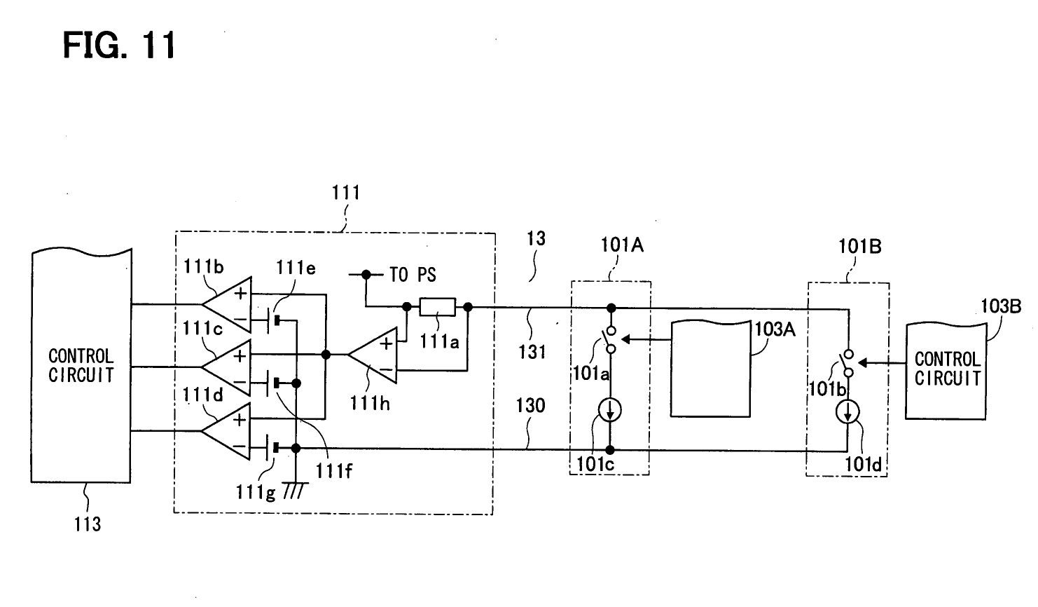

Further, according the first embodiment, a set of the switch 101a and the current source 101c and a set of the switch 101b and the current source 101d are integrally formed as the transmitter circuit 101, and both of the switches 101a, 101b are controlled by the control circuit 103. Alternatively, as shown in FIG. 11, the set of the switch 101a and the current source 101c can be formed as a transmitter circuit 101A, and the set of the switch 101b and the current source 101d can be formed as a transmitter circuit 101B independent of the transmitter circuit 101A. In this case, the switch 101a can be controlled by a control circuit 103A, and the switch 101b can be controlled by a control circuit 103B independent of the control circuit 103A. In this way, multiple sensor units can be connected in series through the communication line 13. Likewise, the switches 110d-110f of the transmitter circuit 110 can be independently configured and controlled.

### Second Embodiment

A second embodiment of the present invention is described below. A difference between the first and second embodiments is as follows. In the first embodiment, multiple binary signals having different amplitudes at a high level are added together to generate a multiplexed binary signal, and the multiplexed binary signal is transmitted and received between the sensor unit 10 and the control unit 11. In contrast, in the second embodiment, multiple binary signals having different amplitudes at a high level are successively transmitted and received between the sensor unit 10 and the control unit 11. It is noted that the second embodiment is the same as the first embodiment in structure but different from the first embodiment in operation.

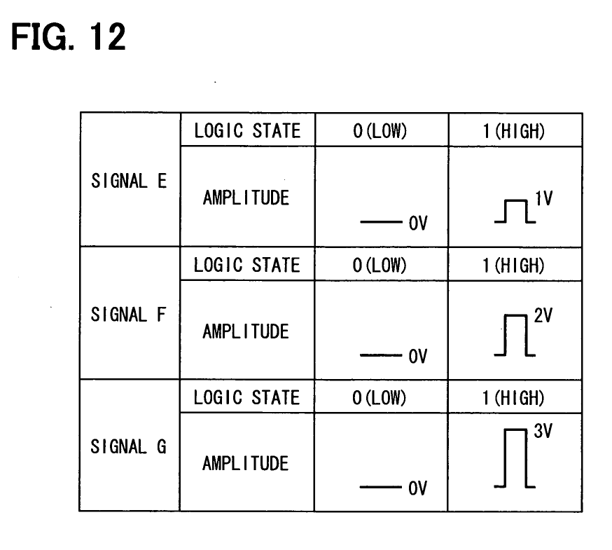

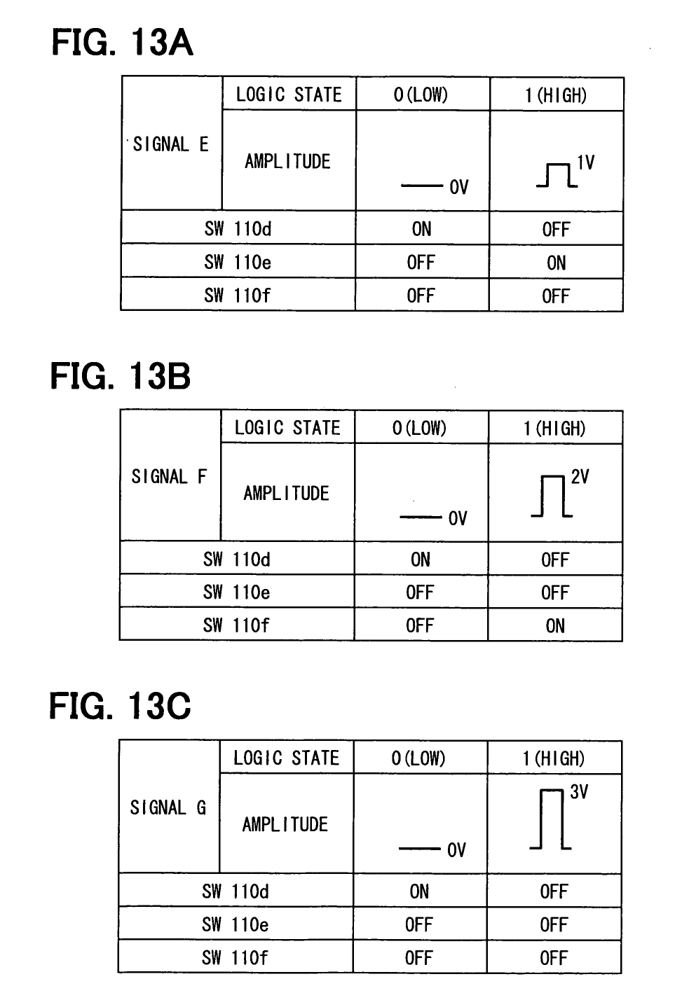

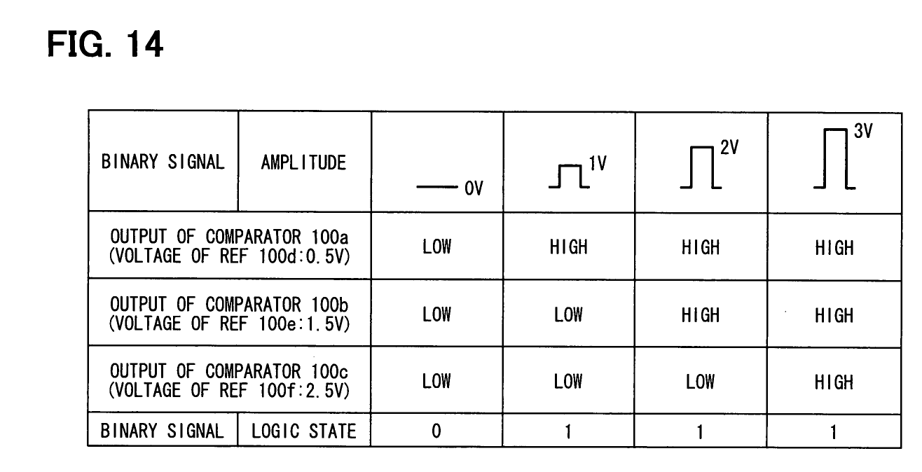

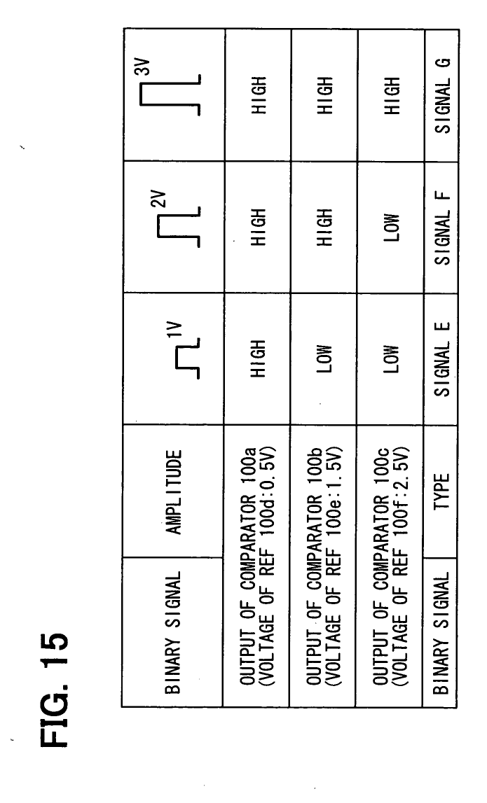

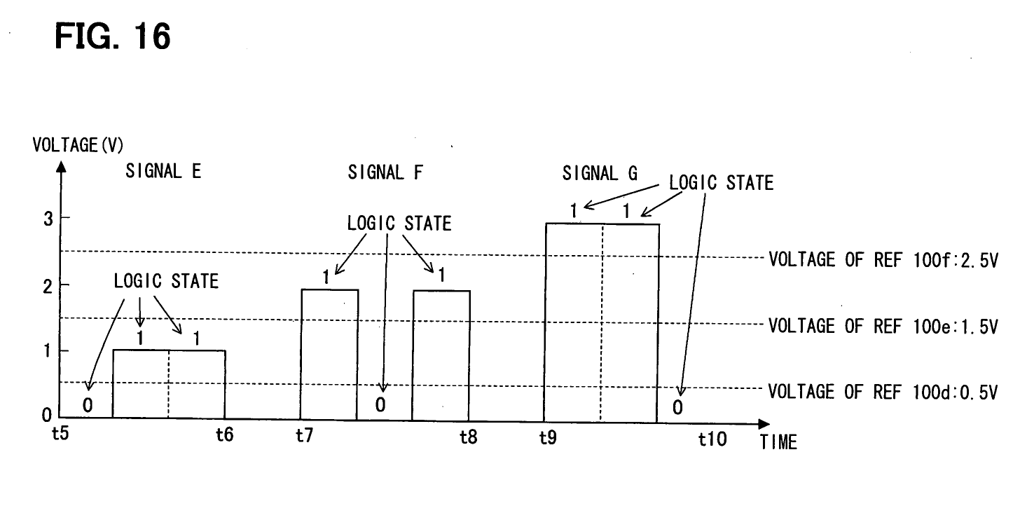

Transmission and reception operations between the transmitter circuit 110 of the control unit 11 and the receiver circuit 100 of the sensor unit 10 are described below with reference to FIGS. 2 and 12-16. FIG. 12 depicts binary signals E, F, and G of the second embodiment. FIG. 13 depicts an operation of generating the signals E, F, and G. FIG. 14 depicts an operation of determining a logic state of a binary signal. FIG. 15 depicts an operation of determining a type of the binary signal. FIG. 16 depicts a timing diagram of the signals E, F, and G.

Firstly, the operation of generating the signals E, F, and G is described. Referring to FIG. 2, the control circuit 113 generates three types of signals E, F, and G including a command to the sensor unit 10. Each of the signals E, F, and G is a binary signal having a high level corresponding to a logic state of “1” and a low level corresponding to a logic state of “0”. As shown in FIG. 12, when the signal E has a logic state of “0” (i.e., low level), an amplitude of the signal E is 0V, and when the signal E has a logic state of “1” (i.e., high level), the amplitude of the signal E is 1V. When the signal F has a logic state of “0” (i.e., low level), an amplitude of the signal F is 0V, and when the signal F has a logic state of “1” (i.e., high level), the amplitude of the signal F is 2V. When the signal G has a logic state of “0” (i.e., low level), an amplitude of the signal G is 0V, and when the signal G has a logic state of “1” (i.e., high level), the amplitude of the signal G is 3V. In summary, the signals E, F, and G have the same amplitude at a low level and have different amplitudes at a high level.

Referring back to FIG. 2, the control circuit 113 controls the switches 110d-110f, thereby successively generating and transmitting the signals E, F, and G. As shown in FIG. 13A, the signal E having a logic state of “0” can be generated by turning ON only the switch 110d, and the signal E having a logic state of “1” can be generated by turning ON only the switch 110e. As shown in FIG. 13B, the signal F having a logic state of “0” can be generated by turning ON only the switch 110d, and the signal F having a logic state of “1” can be generated by turning ON only the switch 110f. As shown in FIG. 13C, the signal G having a logic state of “0” can be generated by turning ON only the switch 110d, and the signal G having a logic state of “1” can be generated by turning OFF all the switches 110d-110f.

In an example shown in FIG. 16, the signal E having a logic state of “011” is generated and transmitted during a period of time from t5 to t6, the signal F having a logic state of “101” is generated and transmitted during a period of time from t7 to t8, and the signal G having a logic state of “110” is generated and transmitted during a period of time from t9 to t10. In this way, the signals E, F, and G having the different amplitudes at a high level are successively generated and transmitted.

Next, the operation of determining the logic state of the binary signal is described: Referring to FIG. 2, the comparators 100a-100c of the receiver circuit 100 compares the voltage of the binary signal transmitted from the transmitter circuit 110 with the voltages of the reference power supplies 100d-100f, respectively.

As shown in FIG. 14, when the binary signal has an amplitude of 0V, each of the comparators 100a-100c outputs a low level signal. Therefore, the control circuit 103 determines that the binary signal has a logic state of “0”. When the binary signal has an amplitude of 1V, the comparator 100a outputs a high level signal, and each of the comparators 100b, 100c outputs a low level signal. Therefore, the control circuit 103 determines that the binary signal has a logic state of “1”. When the binary signal has an amplitude of 2V, each the comparators 100a, 100b outputs a high level signal, and the comparator 100c outputs a low level signal. Therefore, the control circuit 103 determines that the binary signal has a logic state of “1”. When the binary signal has an amplitude of 3V, each of the comparators 100a-100c outputs a high level signal. Therefore, the control circuit 103 determines that the binary signal has a logic state of “1”.

Next, the operation of determining a type of the binary signal is described. As shown in FIG. 15, when the amplitude of the binary signal at a high level is 1V, the control circuit 103 determines that the binary signal is the signal E. When the amplitude of the binary signal at a high level is 2V, the control circuit 103 determines that the binary signal is the signal F. When the amplitude of the binary signal at a high level is 3V, the control circuit 103 determines that the binary signal is the signal G.

In an example shown in FIG. 16, the control circuit 103 determines that the signal E having a logic state of “011” is received during the period of time from t5 to t6, that the signal F having a logic state of “101” is received during the period of time from t7 to t8, and that the signal G having a logic state of “110” is received during a period of time from t9 to t10. In this way, the transmission and reception operations between the transmitter circuit 110 of the control unit 11 and the receiver circuit 100 of the sensor unit 10 are performed.

Transmission and reception operations between the receiver circuit 111 of the control unit 11 and the transmitter circuit 101 of the sensor unit 10 are performed in the same manner as the transmission and reception operations between the transmitter circuit 110 of the control unit 11 and the receiver circuit 100 of the sensor unit 10, except that the binary signal is in the form of an electric current.

As described above, according to the second embodiment of the present invention, three types of binary signals E, F, and G have different amplitudes. In such an approach, the type of the binary signal can be determined based on the amplitude of the binary signal at a high level. That is, information regarding the type of the binary signal is contained in the amplitude of the binary signal. Thus, the amount of information carried between the sensor unit 10 and the control unit 11 can be increased without increasing the frequency of the binary signal.

(Modifications)

The embodiments described above can be modified in various ways. For example, in the second embodiment, the number of types of binary signals is not limited to three. N types of binary signals can be employed in the second embodiment, as long as the N binary signals have different amplitudes at a high level.

Such changes and modifications are to be understood as being within the scope of the present invention as defined by the appended claims.

What is claimed is:

1. A communication apparatus comprising:
a transmitter device configured to generate a multiplexed binary signal by adding N types of binary signals having the same amplitude at a low level and different amplitudes at a high level, where N is an integer more than 1;
a receiver device configured to receive the multiplexed binary signal and translate the multiplexed binary signal into the N types of binary signals; and
a communication line configured to connect the transmitter device and the receiver device, wherein
one of the N types of binary signals has the minimum amplitude of all the N types of binary signals at the high level, and
an amplitude of each of the N types of binary signals at the high level is defined as a product of the minimum amplitude and 2^{M-1}, where M is an integer from 1 to N.

2. The communication apparatus according to claim 1, wherein
the receiver device compares an amplitude of the multiplexed binary signal with a threshold and translates the multiplexed binary signal into the N types of binary signals based on the result of the comparison.

3. The communication apparatus according to claim 2, wherein
the threshold comprises (2^{N}-1) different values.

4. The communication apparatus according to claim 1, wherein
the multiplexed binary signal is in the form of an electric current or voltage.

5. The communication apparatus according to claim 1, wherein
each of the transmitter device and the receiver device is mounted on a vehicle, and
the N types of binary signals includes a command or a response to the command.

6. The communication apparatus according to claim 1 further comprising:
a sensor unit mounted on a vehicle and configured to detect a collision of the vehicle; and
an occupant protection unit mounted on the vehicle and configured to protect an occupant of the vehicle based on a detection result of the sensor unit, wherein
the N types of binary signals includes the detection result.

7. A communication apparatus comprising:
a transmitter device configured to successively transmit a plurality of types of binary signals having the same amplitude at a low level and different amplitudes at a high level; and
a receiver device configured to successively receive the plurality of types of binary signals from the transmitter device; and
a communication line configured to connect the transmitter device and the receiver device, wherein
the receiver device determines a type of the binary signal based on the amplitude of the binary signal at the high level.

8. The communication apparatus according to claim 7, wherein
each of the transmitter device and the receiver device is mounted on a vehicle, and
the plurality of types of binary signals includes a command or a response to the command.

9. The communication apparatus according to claim 7, further comprising:
a sensor unit mounted on a vehicle and configured to detect a collision of the vehicle; and
an occupant protection unit mounted on the vehicle and configured to protect an occupant of the vehicle based on a detection result of the sensor unit, wherein
the plurality of types of binary signals includes the detection result.
